(19) United States
(12) Patent Application Publication
(10) Pub. No.: US 2010/0228951 A1
(43) Pub. Date: Sep. 9, 2010

(54) PARALLEL PROCESSING MANAGEMENT FRAMEWORK

(75) Inventor: Hua Liu, Fairport, NY (US)

Correspondence Address: Xerox Corporation (CDFS), 445 Broad Hollow Rd.-Suite 420, Melville, NY, 11747, US

(73) Assignee: Xerox Corporation, Norwalk, CT (US)

(21) Appl. No.: 12/398,682

(22) Filed: Mar. 5, 2009

(51) Int. Cl. G06F 9/30

(52) U.S. Cl. 712/203; 712/E09.071

(57) ABSTRACT

The present disclosure includes a management framework system for processing a parallel task. The framework includes a job package, a job submitter, task trackers, communicators, a plurality of processors, and a node service. The job package has a bundle of implementations defined by a user and an input data domain. The job submitter module has a splitter interface and a reducer interface. The job submitter is configured to split the input data domain into a plurality of sub-data domains. In addition, the job submitter module is configured to send and receive the plurality of sub-data domains to a plurality of processors. The one or more processors are configured to execute parallel tasks on sub-data domains. The management framework separates user-defined applications from parallel execution such that user-implementations are separated from management framework implementations.

### BACKGROUND

1. Technical Field

The present disclosure relates to parallel processing models and, more particularly, to parallel processing models associated with management frameworks.

2. Description of Related Art

Parallel processing models, for example, map-reduce models, are known in the field of computer programming and networking. An example of a map-reduce model was proposed by GOOGLE for use with simplified data processing on large clusters in 2004. Since then, many companies have been utilizing this concept in their business logistics.

Briefly, parallel processing, which may also be referred to as parallel execution, generally consists of three main steps: i) splitting a data domain into a plurality of sub-data domains on which a parallel task can operate; ii) operating individual parallel tasks on the individual sub-data domains during which the parallel tasks may communicate with each other from other sub-data domains; and iii) collecting sub-results from all parallel tasks and combining them into one output file.

Map-reduce models require users to define parallel tasks and data space partition into map and format classes. Users must also define how the sub-results are gathered in the reduce class. The map-reduce model assumes independent parallel tasks. In other words, independent parallel tasks do not communicate with each other during parallel computations. This is a drawback since, in many cases, a large set of parallel applications require parallel tasks to share data at runtime.

Additionally, other traditional parallel frameworks, such as the Unix based message passing interface (MPI) (http://www-unix.mcs.anl.gov/mpi/), have implementations that support inter-task communication. However, with these types of map-communicate-reduce models users are typically required to have a high degree of understanding and programming skills of parallel processing in order to utilize the inter-task communication feature. Furthermore, the MPI model does not provide a clear separation between application logic and system issues raised by scattering tasks to distributed machines and collecting results from them. These disadvantages hinder the application of these frameworks into business environments.

### SUMMARY

The present disclosure provides a management framework system for processing a parallel job. In an embodiment of the present disclosure, the management framework system includes a job package, a runtime framework interpreting the job package and consisting of job submitters, task trackers, and communicators, a plurality of processors, and a node service. The job package has a bundle of implementations defined by a user and an input data domain. The bundle of implementations may include splitter implementations, mapper implementations, reducer implementation, or a job description file. The job submitter is configured to split the input data domain into a plurality of sub-data domains via interpreting the splitter implementations from the job package. In addition, the job submitter module is configured to send and receive the plurality of sub-data domains to a plurality of task trackers residing on a plurality of processors. The one or more task trackers are configured to execute parallel tasks on sub-data domains. The node service is configured to locate and select the plurality of processors. The job submitter deploys mapper implementations and the plurality of sub-data domains onto the selected plurality of processors. The management framework separates user-defined applications from parallel execution such that user-implementations are separated from management framework implementations.

In embodiments, the management framework system includes a memory module configured to store algorithms, concrete commands, and predetermined implementations. The management framework may be configured to manage the runtime execution and communication of the parallel tasks and communicate the parallelized results back to the job submitter module for reducing by the reducer implemented by a user. The splitter is configured by a user via a splitter implementation to instruct the framework system to split the input data into sub-data domains or data chunks.

The reducer is configured by a user via a reducer implementation to instruct the management framework to combine parallelized sub-data domains into at least one output file. The node service can be implemented by a central registration or a broadcast mechanism to facilitate in discovering ready and able machines to parallelize a plurality of data chunks.

In embodiments, the processor status information of the discovered processors is stored on a memory module whereupon an inquiry sent from a job submitter module allows the node service to provide a status report on all operable and inoperable processors within the management framework system.

In other embodiments, the management framework system may include a mapper interface, which is configured by a user via mapper implementations and instruct the framework system to process each sub-data domain. The management framework is configured to execute parallel tasks without user implementation.

In still other embodiments, the management framework system may include a communicator interface and its implementation duplicated and residing on a plurality of processors. The communicator is configured to automatically discover and communicate with other communicator of the plurality of processors without user implementation.

The present disclosure also provides for a method of executing a parallel job within a management framework. The method includes a step of submitting a job package to a job submitter, the job package having a splitter implementation, a mapper implementation, a reducer implementation, and a job description file. In a next step, one or more processors that are configured to perform a parallel job are discovered.

In a next step, the input data domain is divided into a plurality of sub-data domains by utilizing a splitter. Next, the plurality of sub-data domains is transmitted to a plurality of processors. Then, a mapper disposed in each of the one or more processors initiates the respective processor to execute a parallel process on each of the plurality of sub-data domains. In a next step, the plurality of sub-data domains are reduced via a reducer into at least one output file. In a next step, an output file is outputted to a location defined in the job description file.

In other embodiments, the step of initiating a mapper to execute a parallel job further includes communicating via communicators to check the progress of each of the plurality of processors. The method includes a step for discovering a node service configured to discover a plurality of processors.

The present disclosure also provides for a computer readable medium storing a program causing a computer to execute a parallel process within a management framework. The program includes the step of receiving a job package having a splitter implementation, a mapper implementation, a reducer implementation, and a job description file. The program also includes the step of determining a plurality of processors configured to perform a parallel job. The program also includes the step of dividing the input data domain into a plurality of sub-data domains by utilizing a splitter. The program also includes the step of transmitting the plurality of sub-data domains to a plurality of processors. The program also includes the step of initiating a mapper disposed in each of the plurality of processors to execute a parallel job on each of the plurality of sub-data domains. The program also includes the steps of reducing the plurality sub-data domain via a reducer into at least one output file and outputting the at least one output file a location defined in the job description file.

In other embodiments, the program also includes the step of communicating other mappers via communicator interfaces to check the progress of each of the plurality of processors. The program also includes the step of determining user-defined preferences from basic parallel execution. The program also includes the step of providing management framework implementations without any user input.

### BRIEF DESCRIPTION OF THE DRAWINGS

Various embodiments of the present disclosure will be described herein below with reference to the figures wherein:

FIG. 1 is a schematic diagram of a management framework illustrating a job package, a job submitter module, a node service, and a plurality of machines, according to an embodiment of the present disclosure;

FIG. 2 is a schematic diagram of the management framework of FIG. 1 illustrating a splitter of the job submitter module executing a parallel job;

FIG. 3 is a schematic diagram of the management framework of FIG. 1 illustrating a reducer of the job submitter module executing a parallel job; and

FIG. 4 is a flow chart illustrating a method for executing a parallel job on a management network, in accordance with the present disclosure.

### DETAILED DESCRIPTION

Embodiments of the presently disclosed management framework system and method will now be described in detail with reference to the drawings in which like reference numerals designate identical or corresponding elements in each of the several views.

The present disclosure provides for a management framework, which is generally referenced as 100 in the figures. As will appear, the management framework corresponds with a map-communicate-reduce model that hides the programming and execution complexity, thereby allowing non-computer programmers to easily develop parallel applications.

The management framework 100, which may also be referred to as a runtime framework, separates application and business logic from deployment and execution details. In this manner, a user can focus on business logic and applications, while the management framework 100 executes parallelization details in the background. The model and framework 100 may apply very well to business applications where users typically do not have any expertise in computer programming, particularly in, parallel processing. The framework 100 may be used to parallelize long-running image processing applications, for example, digital picture scanning, digital picture decoding, or image processing.

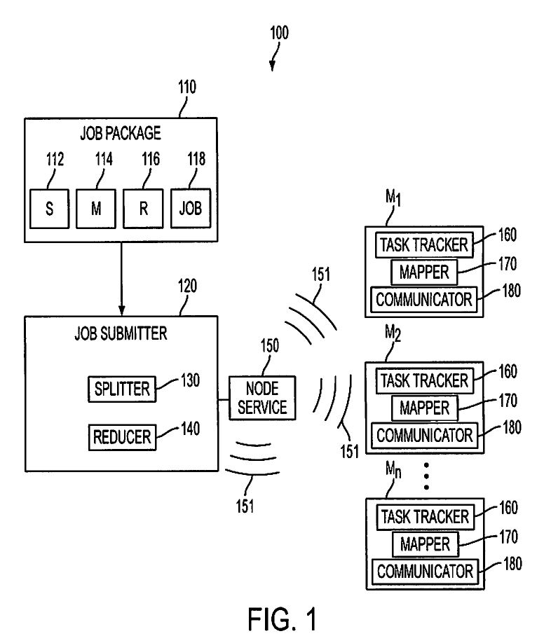

Referring now to FIG. 1, the framework 100 includes a job package 110, a job submitter module 120, a node service 150, and a plurality of machines M1, M2, . . . Mn, in accordance with an embodiment of the present disclosure. It should be noted that although machines are referenced throughout the disclosure, it is envisioned that any suitable processor and/or machine may be utilized to conduct a parallelization process. The framework 100 provides a so-called “backbone” for all of the parallel processing components mentioned above and which will be described in further detail below. It is envisioned that the framework 100 may have a memory module, for example, but not limited to, flash memory, hard-drive memory, or the like to store algorithms, concrete commands, and any other pre-determined implementations.

The job package 110 includes a bundle of user implementations that are packaged together such that package 110 will later be distributed throughout the parallel processing framework 100. For example, a user may present instructions, which may include specifying certain technicalities in splitting data, processing sub-data, and collecting sub-data results into a single output file. The management framework 100 may be configured to execute a job package 110 submitted by a user.

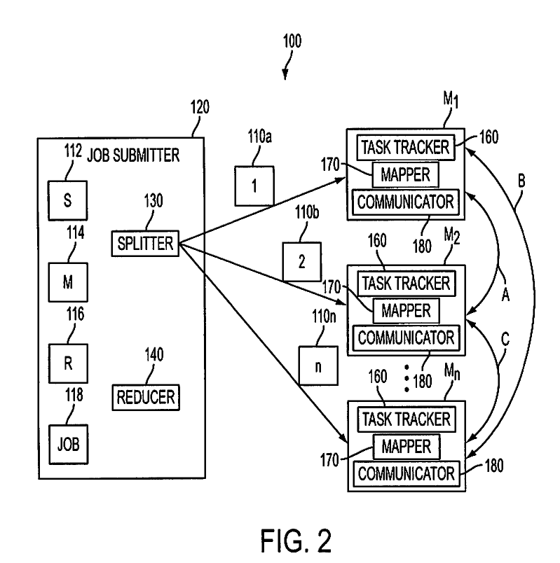

Further, the management framework 100 may be configured to locate and select machines or processors, e.g., M1, and deploy mappers 170 and sub-data domains, e.g., 110a, onto the selected machines M1, M2, . . . Mn. (Shown in FIG. 2). The management framework 100 is further configured to manage the runtime execution and communication of the parallel tasks and communicates the parallelized results back to the job submitter module 120 for reducing by the reducer 140. Each of these steps and processes will be described in detail further below.

With continued reference to FIG. 1, the job package 110 contains a bundle of implementations defined by a user. The bundle of implementations includes splitter implementations 112, mapper implementation 114, reducer implementation 116 and a job description file 118. While all of these implementations are defined by a user, it should be noted that pre-determined, i.e., concrete, implementations may be utilized in place of user-defined implementations. In this situation, the management framework 100 provides for completing a parallelization of a multiple tasks, even when a user has inadvertently or intentionally not entered a specific implementation for a specific interface.

Splitter interface 130 may be implemented by a user via splitter implementations 112 in order to instruct the framework system 100 on how to divide or split the input data domain into sub-data domain or date chunks, e.g., 110a. For example, a user may want to divide a project into a large number of parallel processes to be parallelized by a large number of machines. In this scenario, the parallel processing runtime may be accelerated since many machines are parallelizing at the same time. Alternatively, a user may want to divide or split a project into a small number of parallel processes for other reasons, for example, the granularity of the input data prevents the user from further partitioning, or the increase in processing speed by adding more machines is outpaced by communication overhead.

After the user implements the splitter 130 via splitter implementation 112, the splitter 130 receives the input data from the job package 110, which is labeled as “in” in the below-referenced command. The splitter 130 divides or splits the input data into a user-specified number of data chunks, which is labeled “num” in the below-referenced command. As shown in FIG. 2, the splitter 130 is configured to output a list of data chunks 110a, 110b, . . . 110n to selected machines or processors M1, M2, . . . Mn. In the below-referenced user-interface command, the output list of the data chunks may be indexed by integers. An example of a splitter implementation, e.g., command, may be defined as follows:

```
    public interface Splitter {
    public void split(InputStream in, int num, Map<Integer,
OutputStream> map);
    }
```

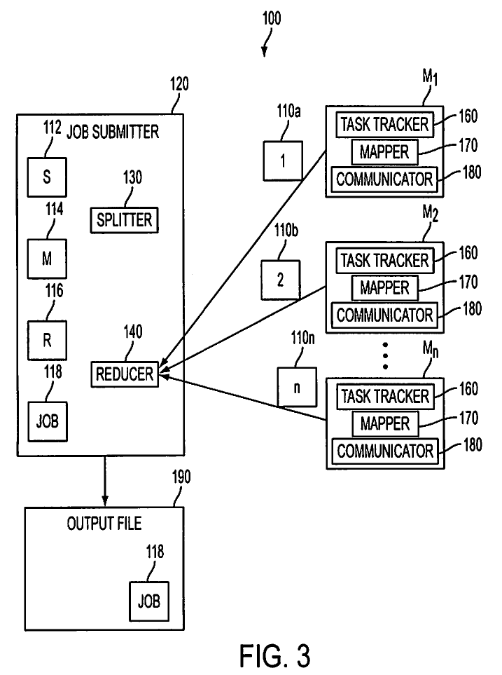

A reducer 140 of framework 100 is implemental by a user via reducer implementations 116, initially provided to the job package 110. The reducer 140 instructs the management framework 100 how to combine parallel results into one output file 190 (Shown in FIG. 3). The mapper command may be defined as follows:

```
    public interface Reducer {
    public void reduce(Map<Integer, InputStream> ins,
OutputStream out);
    }
```

Also shown in FIG. 1 is a node service 150 that searches and discovers machines and/or processors M1, M2, . . . Mn that are ready and available to execute a submitted parallel process. More specifically, node service 150 can be implemented as a central registration or a broadcast mechanism to facilitate in discovering ready and able machines or processors to parallelize a plurality of data chunks. For example, in a central registration node service, all of the processors are found on a server network. In other words, the node service contains all of the status information of all available machines and may also know the status of any machines that may be having “down time.”

In embodiments, the computer status information of the machines may be stored on a suitable memory module whereupon an inquiry sent from a job submitter module 120 will allow the node service to readily provide a status report on all operable and inoperable machines within the network. The memory module may be disposed on any component on the runtime framework system 100, for example, but not limited to, job submitter 120. Alternatively, a broadcast mechanism node service searches for available machines and/or processors M1, M2, . . . Mn across various networks located on the internet and/or intranet. It is envisioned that node service 150 may emit any suitable signal 150a in order to “ping” machines for availability. For example, the signal emitted may be, but not limited to, wireless signal or wired transmission signal, etc.

A mapper interface 170 of framework 100 is implemented by a user via mapper implementations 114 initially provided to the job package 110. The mapper 170 instructs the framework system 100 on how to process each data chunk 110a, 110b, 110n. A user can define different tasks for different data chunks 110a, 110b, 110n (Shown in FIG. 2-3) based on the input parameter “id”, which is the index of a data chunk. The “map” method reads the input data chunk from “in”, and writes any output produced to the output stream referenced by “out”. The mapper command may be defined as follows:

```
    public interface Mapper {
    public void map(int id, InputStream in, OutputStream
out, Communicator comm);
    }
```

The splitter interface 130 of the job submitter 120 executes a parallel task module 120 to machines M1, M2, . . . Mn. As mentioned above, the splitter 130 receives the input data of the job package 110 and divides the data into data chunks 110a, 110b, . . . 110n. The splitter 130 then allocates the data chunks 110a, 110b, . . . 110n to a respective machine M1, M2, . . . Mn.

While a parallel individual task, e.g., 110a, is running and processing on a machine e.g., M1, another parallel individual task, e.g., 110n, may communicate with another parallel individual task on another machine, e.g., Mn, by utilizing a command (e.g., “comm.”), which can be a concrete implementation of the task tracker 160 and the communicator 180 provided by the framework 100 when a map method is called. The task tracker 160 via the communicator 180 provides methods for sending/receiving data to/from parallel tasks from different machines within the network 100, depicted by directional arrows A, B, and C.

In embodiments, a user does not have to be informed on which machines the parallel tasks are being processed. Further, a user may only need to indicate which data chunk a task sends to or receives from using an index number from the user's implementation. The management framework provides information to the task tracker 160 via a communicator implementation of the communicator interface 180 and automatically finds the parallel task that is being processed on the data chunk on a machine. It should be noted that the machine M1, M2, . . . Mn may be, for example, but not limited to, any processing device, computer, internal processor of a computer. In addition, the machine, for example, M1, may be remotely connected, wireless, wired, etc. Further, the task tracker 160 and/or the communicator interface 180 performs the required send/receive operation. The communicator implementation provided by the management framework 100 eliminates the need for a user to provide a communicator implementation which may be stored on a memory module on the management framework 100. For example, the memory module may be stored on the task tracker 160, job submitter 120 or any other location on the management framework 100. That is, the user can disregard submitting any the communicator implementations. The communicator command may defined as follows:

public interface Communicator {
public void send (int to, InputStream from);
public void receive (int from, OutputStream to);
}

As shown in FIG. 3, the management framework 100 illustrates the reducer interface 140 of the job submitter 120 collecting all of the data chunks 110a, 110b, 110n after each data chunk has been processed by the respective machine and/or processor. In this manner, the reducer interface 140 collects or “reduces” the data chunks 110a, 110b, . . . 110n into a single output file 190. The job file properties 118 may provide user-defined implementations for each of the splitter interface 130, reducer interface 140, and mapper interface 170. In addition, the job file properties 118 may provide any other user-defined instructions, for example, but not limited to, an output location for the parallelized output file.

The user-defined implementations describe application logic and can be dynamically loaded, instantiated, and/or invoked by the management framework 100. The management framework 100 is configured to separate the application logic from the deployment and execution of applications such that users need only focus on the application logic, while the components of the framework 100 (e.g., task tracker 160) manages the management issues such as, for example, but not limited to, task deployment, synchronization, deadlock detection, and failure rollover of the components of the framework 100 (e.g., machines, node service, and/or job submitter).

In embodiments, the framework 100 can be enhanced with new functionalities without impacting a user's implementation and/or code. For example, the node service 150 or the task tracker 160 can be configured to provide the capability of prioritizing the plurality of machines and setting a threshold to filter out low-power machines from a candidate list.

In another embodiment, the communicator interface 180 can be configured to provide a recordation and/or monitor in real-time the status of the working machines or machines on stand-by. In addition, the communicator interface 180 can communicate the recorded or real-time status information of the machines, e.g., M1, to task tracker 160 and/or job submitter 120 if any task failures occur. In this scenario, the job submitter 120 can select another machine, e.g., Mn, to perform a selected task. The task is then re-deployed and submitted to newly discovered or previously discovered ready and able machines.

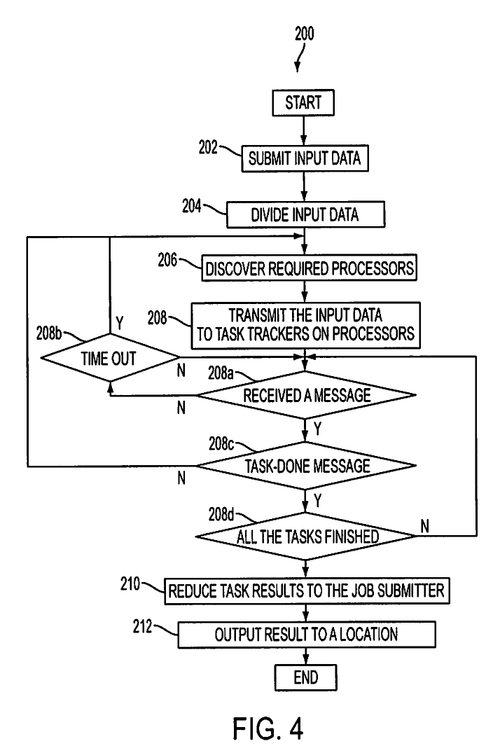

With reference to FIG. 4, a flow chart is presented illustrating a method for executing a parallel job on a management network, in accordance with the present disclosure.

The method 200 includes the following steps described herein below. In step 202, a user submits the parallel job package 110 to a job submitter 120. The parallel job package 110 includes a splitter implementation 112, a mapper implementation 114, a reducer implementation 116, and a job description file 118 as described above.

In step 204, the job submitter 120 divides the input data into user-defined chunks 110a, 110b, . . . 110n using the splitter interface 130.

In step 206, or during step 202 and/or 204, the job submitter 120 discovers one or more machines M1, M2, . . . Mn, which are configured to process parts of the parallel job package 110. In embodiments, the node service 150 can be used to discover one or more machines M1, M2, . . . Mn. In step 208, the job submitter 120 transmits the mapping implementation 114 and data chunks 110a, 110b, . . . 110n to task trackers 160 on the selected machines. The task trackers 160 then instantiate mapper 170 which process the data chunks 110a, 110b, . . . 110n. In addition, mapper 170 communicate with other mapper interfaces 170 through communicator interfaces 180 depicted by arrows A, B, and C. (Shown in FIG. 2). Steps 208a, 208b, 208c, and 208d include feedback loop queries to monitor the progress during and/or after the parallelized data chunks 110a, 110b, . . . 110n have been executed.

In embodiments, the runtime framework monitors whether the resulting data chunks 110a, 110b, . . . 110n are sent back to the job submitter 120 successfully an complete. For example, in step 208a the mapper interfaces 170 communicate via the communicator interfaces 180 whether a message has been received. In step 208b, the mappers 170 communicate via the communicator interfaces 180 if there has been a time out, which in this case, other processors may need to be discovered to complete the task (step 206). In step 208c, the mappers 170 check if the task has been completed, which may be accomplished by receiving a “task-done” message from the communicator interfaces 180 from each processor/machine. In the situation, where a task has not been completed, i.e., a “task-done” message has not been received, other processors may need to be discovered to complete the task (step 206).

In step 210, the job submitter 160 uses reducer interface 140 to combine and “reduce” the data chunk results into one output file 190. In step 212, the job submitter 120 writes the output file 190 to a location described in the job description file 118.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A management framework system for processing a parallel job, the system comprising:
a job package having a bundle of implementations defined by a user and an input data domain;
a job submitter module communicating with said job package, said job submitter having a splitter and a reducer and configured to split the input data domain into a plurality of sub-data domains, the job submitter module further configured to send and receive the plurality of sub-data domains to a plurality of processors, the plurality of processors being configured to execute parallel tasks on sub-data domains; and
a node service communicating with the plurality of processors, said node service being configured to (1) locate and select one or more of the plurality of processors, and (2) send the processor information to the job submitter, which then deploys a mapper and the plurality of sub-data domains onto the one or more of the plurality of processors, wherein the management framework determines user-defined preferences from basic parallel execution such that user-implementations are separated from management framework implementations.

2. The management framework system according to claim 1 further comprising:
a memory module configured to store algorithms, concrete commands, and pre-determined implementations.

3. The management framework system according to claim 1, wherein the management framework is configured to manage the runtime execution and communication of the parallel tasks and communicate the parallelized results back to the job submitter module for reducing by the reducer.

4. The management framework system according to claim 1, wherein the bundle of implementations defined by a user are selected from the group consisting of splitter implementations, mapper implementations, reducer implementation, and a job description file.

5. The management framework system according to claim 1, wherein the splitter is configured by a user via a splitter implementation to instruct the framework system to split the input data into sub-data domains.

6. The management framework system according to claim 1, wherein the reducer is defined by a user via a reducer implementation to instruct the management framework to combine parallelized sub-data domains into at least one output file.

7. The management framework system according to claim 1, wherein the node service can be implemented by a group consisting of a central registration and a broadcast mechanism to facilitate in discovering ready and able machines to parallelize the plurality of sub-data domains.

8. The management framework system according to claim 7, wherein the processor information of the discovered processors is stored on a memory module whereupon an inquiry sent from a job submitter module allows the node service to provide a status report on all operable and inoperable processors within the management framework system.

9. The management framework system according to claim 1, further comprising a mapper and configured to provide a job package to a processor by a user via mapper implementations and instruct the framework system to process each sub-data domain.

10. The management framework system according to claim 1, wherein the management framework is configured to execute parallel tasks without user monitoring and intervention.

11. The management framework system according to claim 1, further comprising a communicator interface implemented within each of the plurality of processors, wherein the communicator interface is configured to automatically discover and communicate with other communicator interfaces of the plurality of processors without user implementation.

12. A method of executing a parallel process within a management framework, the method comprising:
receiving a parallel job package having a splitter implementation, a mapper implementation, a reducer implementation, and a job description file;
dividing the input data domain into a plurality of sub-data domains by utilizing a splitter;
transmitting the plurality of sub-data domains to a plurality of processors;
initiating a mapper disposed in each of the plurality of processors to execute a parallel process on each of the plurality of sub-data domains;
reducing the plurality sub-data domain via a reducer into at least one output file; and
outputting the at least one output file a location defined in the job description file.

13. The method of executing a parallel process within a management framework according to claim 12, wherein the step of initiating a mapper to execute a parallel process further comprises:
communicating amongst mappers via communicator interface to check the progress of each of the plurality of processors.

14. The method of executing a parallel process within a management framework according to claim 12, further comprising:
utilizing a node service configured to discover a plurality of processors.

15. The method of executing a parallel process within a management framework according to claim 12, further comprising:
determining user-defined preferences from basic parallel execution.

16. The method of executing a parallel process within a management framework according to claim 15, further comprising:
providing management framework implementations without any user input.

17. A computer readable medium storing a program causing a computer to execute a parallel process within a management framework, the program comprising:
receiving a parallel job package having a splitter implementation, a mapper implementation, a reducer implementation, and a job description file;
dividing the input data domain into a plurality of sub-data domains by utilizing a splitter interface;
transmitting the plurality of sub-data domains to a plurality of processors;
initiating a mapper disposed in each of the plurality of processors to execute a parallel process on each of the plurality of sub-data domains;
reducing the plurality sub-data domain via a reducer into at least one output file; and
outputting the at least one output file a location defined in the job description file.

18. The computer readable medium according to claim 17, further comprising:
communicating other mapper interfaces via communicators to check the progress of each of the plurality of processors.

19. The computer readable medium according to claim 17, further comprising:
determining user-defined preferences from basic parallel execution.

20. The computer readable medium according to claim 19, further comprising
providing management framework implementations without any user input.
